(19) United States
(12) Patent Application Publication
(10) Pub. No.: US 2021/0033276 A1
(43) Pub. Date: Feb. 4, 2021

(54) COMPREHENSIVE PERFORMANCE MEASUREMENT SYSTEM FOR INSULATION STRUCTURE OF BOILER SETTING

(71) Applicant: China Special Equipment Inspection and Research Institute, Beijing (CN)

(72) Inventors: Guoli Qi, Beijing (CN); Songsong Zhang, Beijing (CN)

(73) Assignee: China Special Equipment Inspection and Research Institute, Beijing (CN)

(21) Appl. No.: 16/844,397

(22) Filed: Apr. 9, 2020

(30) Foreign Application Priority Data
Jul. 30, 2019 (CN) 201910697314.4

(51) Int. Cl. F22B 37/38; G01N 25/18; F22B 35/18

(52) U.S. Cl. CPC F22B 37/38; F22B 35/18; G01N 25/18

(57) ABSTRACT

A system is disclosed. The system includes a boiler setting system, a heating system, a burner, an inner layer temperature measurement system and an outer wall temperature measurement system, where the boiler setting system includes four vertically arranged, interconnected bottom supported heavy walls and/or sectional supporting water cooled walls; the bottom supported heavy wall includes a refractory brick layer, a first insulation layer and a machine-made red brick layer in order from the inside to the outside; the sectional supporting water cooled wall includes a second insulation layer, an air interlayer and a steel plate in order from the inside to the outside; the heating system includes a membrane wall and a smooth tube; the membrane wall is fixed inside the bottom supported heavy wall; the smooth tube is fixed inside the sectional supporting water cooled wall; the burner is fixed on the inside bottom of the boiler setting system.

### TECHNICAL FIELD

The present invention relates to the technical field of boiler setting structures, and in particular, to a comprehensive performance measurement system for an insulation structure of a boiler setting.

### BACKGROUND

A boiler setting is generally composed of a refractory layer, an insulation layer, and a thermal-protective layer, which serves to protect the furnace shell and reduce heat loss. The thickness of these layers is determined according to the temperature of the furnace shell and the interface temperature of the refractory material used. Because the temperature of the boiler setting gradually increases from bottom to top, the thickness of the refractory layer and the insulation layer varies with different heights. Generally, for the lower area with large temperature and load, it's better to use thick refractory bricks, and provide small expansion gaps for the thin insulation layer. For the upper high-temperature area, despite of a small load, the insulation layer should be thickened to reduce heat loss, except for the refractory layer. The boiler setting is divided into bottom supported heavy wall, sectional supporting water cooled wall and top supported water cooled wall according to different bearing modes and mass per unit area.

The insulation performance of the boiler setting plays a key role in the combustion performance of the boiler, so it is important to research the performance of the insulation structure of the boiler setting. However, in the prior art, there is a lack of research on the design of the insulation structure of the boiler setting.

Therefore, to realize a high-performance boiler setting structure, it is urgent for those skilled in the art to provide a comprehensive performance measurement system for an insulation structure of a boiler setting.

### SUMMARY

In view of this, the present invention provides a comprehensive performance measurement system for an insulation structure of a boiler setting. The present invention effectively measures the performance of the insulation structure of the boiler setting, and provides a structural design parameter of the boiler setting for a boiler manufacturer, etc.

To achieve the above objective, the present invention adopts the following technical solutions.

A comprehensive performance measurement system for an insulation structure of a boiler setting includes a boiler setting system, a heating system, a burner, an inner layer temperature measurement system and an outer wall temperature measurement system, where

the boiler setting system includes four vertically arranged, interconnected bottom supported heavy walls and/or sectional supporting water cooled walls; the bottom supported heavy wall includes a refractory brick layer, a first insulation layer and a machine-made red brick layer in order from the inside to the outside; the sectional supporting water cooled wall includes a second insulation layer, an air interlayer and a steel plate in order from the inside to the outside;

the heating system includes a membrane wall and a smooth tube; the membrane wall is fixed inside the bottom supported heavy wall; the smooth tube is fixed inside the sectional supporting water cooled wall;

the burner is fixed on the inside bottom of the boiler setting system;

the inner layer temperature measurement system is configured to measure the temperature of the first insulation layer and/or the second insulation layer one by one;

the outer wall temperature measurement system is configured to measure the temperature of the machine-made red brick layer and/or the steel plate.

Through the above technical solution, the present invention provides an efficient comprehensive performance measurement system for an insulation structure of a boiler setting. The present invention adjusts the thickness of various layers of the bottom supported heavy wall and the sectional supporting water cooled wall by collecting the temperature, and evaluates the optimal insulation structure through continuous measurement. The present invention saves a material and reduces heat loss, minimizing the use of resources and energy.

Preferably, in the above-mentioned comprehensive performance measurement system for an insulation structure of a boiler setting, there are a total of 24 combinations of the membrane wall and the smooth tube on the boiler setting system. The membrane wall and the smooth tube are in selective combinations to evaluate the insulation effect. The membrane wall and the smooth tube are matched with the bottom supported heavy wall and the sectional supporting water cooled wall as required, and are respectively arranged on different walls.

Preferably, the above-mentioned comprehensive performance measurement system for an insulation structure of a boiler setting further includes a rear pass heating system, where the rear pass heating system includes an economizer, an air heater and a fan; the economizer communicates with a rear pass gas channel of the boiler setting system; the air heater communicates with an outlet of the economizer and exhausts a smoke into the atmosphere; the fan extracts the smoke into the air heater. The present invention effectively reuses the waste heat of the smoke and realizes a good energy conservation effect.

Preferably, in the above-mentioned comprehensive performance measurement system for an insulation structure of a boiler setting, a tube of the economizer is charged with water as a working medium; a tube of the air heater is charged with air as a working medium. The present invention effectively guarantees the effect of waste heat recovery.

Preferably, the above-mentioned comprehensive performance measurement system for an insulation structure of a boiler setting further includes a water supply system, where the water supply system includes a water pump, a water treatment device, a membrane wall header and a smooth tube header; the water pump communicates with an inlet of the water treatment device; an outlet of the water treatment device communicates with a working medium inlet of the economizer; an inlet of the membrane wall header communicates with a working medium outlet of the economizer; an outlet of the membrane wall header communicates with an inlet of the membrane wall; an inlet of the smooth tube header communicates with the working medium outlet of the economizer; an outlet of the smooth tube header communicates with an inlet of the smooth tube. The present invention effectively ensures the supply of the working medium and heat to the membrane wall and the smooth tube.

Preferably, the above-mentioned comprehensive performance measurement system for an insulation structure of a boiler setting further includes a water outlet system, where the water outlet system includes a heat exchanger and a cooling tower; the heat exchanger communicates with an outlet of the membrane wall and/or the smooth tube; the cooling tower communicates with the heat exchanger and is configured to discharge sewage to a blowoff pipe. The present invention effectively treats the discharged sewage.

Preferably, in the above-mentioned comprehensive performance measurement system for an insulation structure of a boiler setting, the first insulation layer is an insulation material or an air interlayer. The insulation material and the air interlayer both meet the insulation requirement of the bottom supported heavy wall and increase the diversity of the boiler setting structure.

Preferably, in the above-mentioned comprehensive performance measurement system for an insulation structure of a boiler setting, when a surface area of the first insulation layer and the second insulation layer is greater than 1 m2, the inner layer temperature measurement system measures the temperature by using a thermocouple arranged by a grid method; when the surface area of the first insulation layer and the second insulation layer is less than or equal to 1 m2, the inner layer temperature measurement system measures the temperature by using three or more temperature probes. The present invention effectively realizes the accurate temperature measurement of the first insulation layer and the second insulation layer.

Preferably, in the above-mentioned comprehensive performance measurement system for an insulation structure of a boiler setting, the outer wall temperature measurement system measures the temperature of an outer wall of the boiler setting system by using a wall-adhered thermocouple or an infrared ray; the wall-adhered thermocouple performs blackness correction when the infrared ray measurement is adopted. The present invention effectively realizes the accurate temperature measurement of the outer wall of the boiler setting system.

Preferably, in the above-mentioned comprehensive performance measurement system for an insulation structure of a boiler setting, the working medium in the membrane wall and/or the smooth tube is water, steam or an organic heat carrier; the pressure of the working medium is adjusted within 0-31 MPa and the temperature of the working medium is adjusted within 20-650° C. The present invention ensures the adjustable pressure and temperature of the working medium in the tube, as well as diversified experimental measurement and high measurement accuracy.

As can be seen in the above-mentioned technical solution, the present invention provides a comprehensive performance measurement system for an insulation structure of a boiler setting. Compared with the prior art, the measurement system allows adjustment of the thickness of the refractory brick layer, the first insulation layer, the machine-made red brick layer, the second insulation layer, the air interlayer and the steel plate. The measurement system adjusts the thickness of various layers of the bottom supported heavy wall and the sectional supporting water cooled wall by collecting the temperature, and evaluates the optimal insulation structure through continuous measurement. With this measurement system, the boiler setting structure saves an insulation material and effectively reduces the heat loss of a boiler, minimizing the use of resource and energy.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show the embodiments of the present invention, and a person of ordinary skill in the art may still derive other drawings from the provided accompanying drawings without creative efforts.

FIG. 1 is a structural diagram of an overall system provided by the present invention.

FIG. 2 is a front sectional view of a boiler setting system provided by an the present invention;

FIG. 3 is a top sectional view of a boiler setting system provided by the present invention.

### REFERENCE NUMERALS

1. boiler setting system;

11. bottom supported heavy wall;

111. refractory brick layer

112. first insulation layer;

113. machine-made red brick layer;

12. sectional supporting water cooled wall;

121. second insulation layer;

122. air interlayer;

123. steel plate;

2. heating system;

21. membrane wall;

22. smooth tube;

3. burner;

4. rear pass heating system

41. economizer;

42. air heater;

43. fan

5. water supply system;

51. water pump;

52. water treatment device;

53. membrane wall header;

54. smooth tube header;

6. water outlet system;

61. heat exchanger;

62. cooling tower.

### DETAILED DESCRIPTION

The following clearly and completely describes the technical solutions in the embodiments of the present invention with reference to accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts should fall within the protection scope of the present invention.

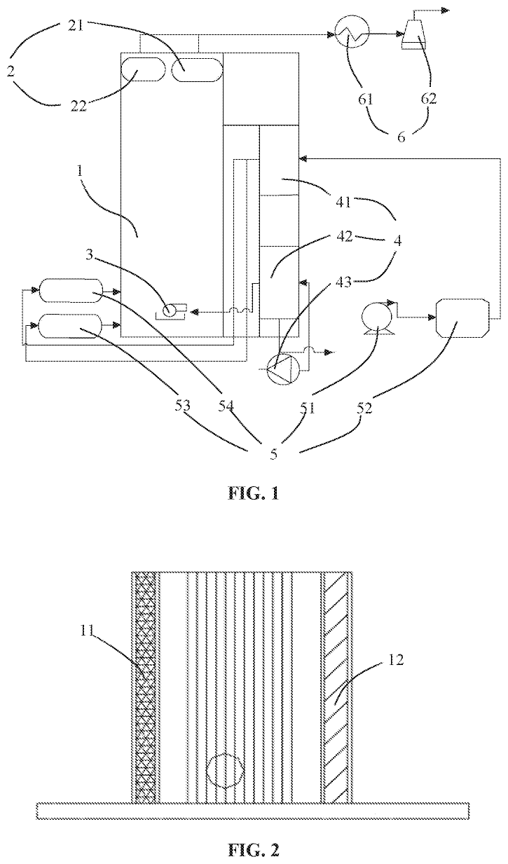

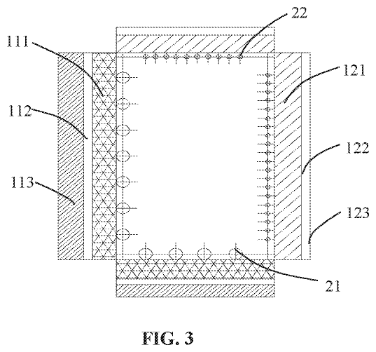

Referring to FIG. 1 to FIG. 3, an embodiment of the present invention provides a comprehensive performance measurement system for an insulation structure of a boiler setting, including: a boiler setting system 1, a heating system 2, a burner 3, an inner layer temperature measurement system and an outer wall temperature measurement system, where

the boiler setting system 1 includes four vertically arranged, interconnected bottom supported heavy walls 11 and/or sectional supporting water cooled walls 12; the bottom supported heavy wall 11 includes a refractory brick layer 111, a first insulation layer 112 and a machine-made red brick layer 113 in order from the inside to the outside; the sectional supporting water cooled wall 12 includes a second insulation layer 121, an air interlayer 122 and a steel plate 123 in order from the inside to the outside;

the heating system 2 includes a membrane wall 21 and a smooth tube 22; the membrane wall 21 is fixed inside the bottom supported heavy wall 11; the smooth tube 22 is fixed inside sectional supporting water cooled wall 12;

the burner 3 is fixed on the inside bottom of the boiler setting system 1;

the inner layer temperature measurement system is configured to measure the temperature of the first insulation layer 112 and/or the second insulation layer 121 one by one;

the outer wall temperature measurement system is configured to measure the temperature of the machine-made red brick layer 113 and/or the steel plate 123.

In order to further optimize the above technical solution, there are a total of 24 combinations of the membrane wall 21 and the smooth tube 22 on the boiler setting system 1.

In order to further optimize the above technical solution, the measurement system further includes a rear pass heating system 4, where the rear pass heating system 4 includes an economizer 41, an air heater 42 and a fan 43; the economizer 41 communicates with a rear pass gas channel of the boiler setting system 1; the air heater 42 communicates with an outlet of the economizer 41 and exhausts a smoke into the atmosphere; the fan 43 extracts the smoke into the air heater 42.

In order to further optimize the above technical solution, a tube of the economizer 41 is charged with water as a working medium; a tube of the air heater 42 is charged with air as a working medium.

In order to further optimize the above technical solution, the measurement system further includes a water supply system 5, where the water supply system 5 includes a water pump 51, a water treatment device 52, a membrane wall header 53 and a smooth tube header 54; the water pump 51 communicates with an inlet of the water treatment device 52; an outlet of the water treatment device 52 communicates with a working medium inlet of the economizer 41; an inlet of the membrane wall header 53 communicates with a working medium outlet of the economizer 41; an outlet of the membrane wall header 53 communicates with an inlet of the membrane wall 21; an inlet of the smooth tube header 54 communicates with the working medium outlet of the economizer 41; an outlet of the smooth tube header 54 communicates with an inlet of the smooth tube 22.

In order to further optimize the above technical solution, the measurement system further includes a water outlet system 6, where the water outlet system 6 includes a heat exchanger 61 and a cooling tower 62; the heat exchanger 61 communicates with an outlet of the membrane wall 21 and/or the smooth tube 22; the cooling tower 62 communicates with the heat exchanger 61 and is configured to discharge sewage to a blowoff pipe.

In order to further optimize the above technical solution, the first insulation layer 112 is an insulation material or an air interlayer.

In order to further optimize the above technical solution, when a surface area of the first insulation layer 112 and the second insulation layer 121 is greater than 1 m2, the inner layer temperature measurement system measures the temperature by using a thermocouple arranged by a grid method; when the surface area of the first insulation layer 112 and the second insulation layer 121 is less than or equal to 1 m2, the inner layer temperature measurement system measures the temperature by using three or more temperature probes.

In order to further optimize the above technical solution, the outer wall temperature measurement system measures the temperature of an outer wall of the boiler setting system 1 by using a wall-adhered thermocouple or an infrared ray; the wall-adhered thermocouple performs blackness correction when the infrared ray measurement is adopted.

In order to further optimize the above technical solution, the working medium in the membrane wall 21 and/or the smooth tube 22 is water, steam or an organic heat carrier; the pressure of the working medium is adjusted within 0-31 MPa and the temperature of the working medium is adjusted within 20-650° C.

The present invention has the following measurement principle:

The present invention measures the temperature of the boiler setting system 1 to evaluate the performance of the insulation structure of the boiler setting. The measurement system allows adjustment of the thickness of the refractory brick layer 111, the first insulation layer 112, the machine-made red brick layer 113, the second insulation layer 121, the air interlayer 122 and the steel plate 123. The measurement system adjusts the thickness of various layers of the bottom supported heavy wall 11 and the sectional supporting water cooled wall 12 by collecting the temperature, and evaluates the optimal insulation structure through continuous measurement. With this measurement system, the boiler setting structure saves an insulation material and effectively reduces the heat loss of a boiler, minimizing the use of resource and energy.

Each embodiment of the present specification is described in a progressive manner, each embodiment focuses on the difference from other embodiments, and the same and similar parts between the embodiments may refer to each other. For a device disclosed in the embodiments, since it corresponds to the method disclosed in the embodiments, the description is relatively simple, and reference can be made to the method description.

The above illustration of the disclosed embodiments can enable a person skilled in the art to implement or practice the present invention. Various modifications to these embodiments are readily apparent to a person skilled in the art, and the generic principles defined herein may be practiced in other embodiments without departing from the spirit or scope of the invention. Thus, the present invention is not limited to the embodiments shown herein but falls within the widest scope consistent with the principles and novel features disclosed herein.

1. A comprehensive performance measurement system for an insulation structure of a boiler setting, comprising: a boiler setting system (1), a heating system (2), a burner (3), an inner layer temperature measurement system and an outer wall temperature measurement system, wherein
the boiler setting system (1) comprises four vertically arranged, interconnected bottom supported heavy walls (11) and/or sectional supporting water cooled walls (12); the bottom supported heavy wall (11) comprises a refractory brick layer (111), a first insulation layer (112) and a machine-made red brick layer (113) in order from the inside to the outside; the sectional supporting water cooled wall (12) comprises a second insulation layer (121), an air interlayer (122) and a steel plate (123) in order from the inside to the outside;
the heating system (2) comprises a membrane wall (21) and a smooth tube (22); the membrane wall (21) is fixed inside the bottom supported heavy wall (11); the smooth tube (22) is fixed inside the sectional supporting water cooled wall (12);
the burner (3) is fixed on the inside bottom of the boiler setting system (1);
the inner layer temperature measurement system is configured to measure the temperature of the first insulation layer (112) and/or the second insulation layer (121) one by one;
the outer wall temperature measurement system is configured to measure the temperature of the machine-made red brick layer (113) and/or the steel plate (123).

2. The comprehensive performance measurement system for an insulation structure of a boiler setting according to claim 1, wherein there are a total of 24 combinations of the membrane wall (21) and the smooth tube (22) on the boiler setting system (1).

3. The comprehensive performance measurement system for an insulation structure of a boiler setting according to claim 1 further comprising a rear pass heating system (4), wherein the rear pass heating system (4) comprises an economizer (41), an air heater (42) and a fan (43); the economizer (41) communicates with a rear pass gas channel of the boiler setting system (1); the air heater (42) communicates with an outlet of the economizer (41) and exhausts a smoke into the atmosphere; the fan (43) extracts the smoke into the air heater (42).

4. The comprehensive performance measurement system for an insulation structure of a boiler setting according to claim 3, wherein a tube of the economizer (41) is charged with water as a working medium; a tube of the air heater (42) is charged with air as a working medium.

5. The comprehensive performance measurement system for an insulation structure of a boiler setting according to claim 4, wherein a tube of the economizer (41) is charged with water as a working medium; a tube of the air heater (42) is charged with air as a working medium.

6. The comprehensive performance measurement system for an insulation structure of a boiler setting according to claim 5 further comprising a water supply system (5), wherein the water supply system (5) comprises a water pump (51), a water treatment device (52), a membrane wall header (53) and a smooth tube header (54); the water pump (51) communicates with an inlet of the water treatment device (52); an outlet of the water treatment device (52) communicates with a working medium inlet of the economizer (41); an inlet of the membrane wall header (53) communicates with a working medium outlet of the economizer (41); an outlet of the membrane wall header (53) communicates with an inlet of the membrane wall (21); an inlet of the smooth tube header (54) communicates with the working medium outlet of the economizer (41); an outlet of the smooth tube header (54) communicates with an inlet of the smooth tube (22).

7. The comprehensive performance measurement system for an insulation structure of a boiler setting according to claim 1, wherein the first insulation layer (112) is an insulation material or an air interlayer.

8. The comprehensive performance measurement system for an insulation structure of a boiler setting according to claim 1, wherein when a surface area of the first insulation layer (112) and the second insulation layer (121) is greater than 1 m², the inner layer temperature measurement system measures the temperature by using a thermocouple arranged by a grid method; when the surface area of the first insulation layer (112) and the second insulation layer (121) is less than or equal to 1 m², the inner layer temperature measurement system measures the temperature by using three or more temperature probes.

9. The comprehensive performance measurement system for an insulation structure of a boiler setting according to claim 1, wherein the outer wall temperature measurement system measures the temperature of an outer wall of the boiler setting system (1) by using a wall-adhered thermocouple or an infrared ray; the wall-adhered thermocouple performs blackness correction when the infrared ray measurement is adopted.

10. The comprehensive performance measurement system for an insulation structure of a boiler setting according to claim 1, wherein the working medium in the membrane wall (21) and/or the smooth tube (22) is water, steam or an organic heat carrier; the pressure of the working medium is adjusted within 0-31 MPa and the temperature of the working medium is adjusted within 20-650° C.

11. The comprehensive performance measurement system for an insulation structure of a boiler setting according to claim 2 further comprising a rear pass heating system (4), wherein the rear pass heating system (4) comprises an economizer (41), an air heater (42) and a fan (43); the economizer (41) communicates with a rear pass gas channel of the boiler setting system (1); the air heater (42) communicates with an outlet of the economizer (41) and exhausts a smoke into the atmosphere; the fan (43) extracts the smoke into the air heater (42).

12. The comprehensive performance measurement system for an insulation structure of a boiler setting according to claim 5 further comprising a water supply system (5), wherein the water supply system (5) comprises a water pump (51), a water treatment device (52), a membrane wall header (53) and a smooth tube header (54); the water pump (51) communicates with an inlet of the water treatment device (52); an outlet of the water treatment device (52) communicates with a working medium inlet of the economizer (41); an inlet of the membrane wall header (53) communicates with a working medium outlet of the economizer (41); an outlet of the membrane wall header (53) communicates with an inlet of the membrane wall (21); an inlet of the smooth tube header (54) communicates with the working medium outlet of the economizer (41); an outlet of the smooth tube header (54) communicates with an inlet of the smooth tube (22).

13. The comprehensive performance measurement system for an insulation structure of a boiler setting according to claim 1 further comprising a water outlet system (6), wherein the water outlet system (6) comprises a heat exchanger (61) and a cooling tower (62); the heat exchanger (61) communicates with an outlet of the membrane wall (21) and/or the smooth tube (22); the cooling tower (62) communicates with the heat exchanger (61) and is configured to discharge sewage to a blowoff pipe.

14. The comprehensive performance measurement system for an insulation structure of a boiler setting according to claim 2, further comprising a water outlet system (6), wherein the water outlet system (6) comprises a heat exchanger (61) and a cooling tower (62); the heat exchanger (61) communicates with an outlet of the membrane wall (21) and/or the smooth tube (22); the cooling tower (62) communicates with the heat exchanger (61) and is configured to discharge sewage to a blowoff pipe.

15. The comprehensive performance measurement system for an insulation structure of a boiler setting according to claim 3, further comprising a water outlet system (6), wherein the water outlet system (6) comprises a heat exchanger (61) and a cooling tower (62); the heat exchanger (61) communicates with an outlet of the membrane wall (21) and/or the smooth tube (22); the cooling tower (62) communicates with the heat exchanger (61) and is configured to discharge sewage to a blowoff pipe.

16. The comprehensive performance measurement system for an insulation structure of a boiler setting according to claim 11, further comprising a water outlet system (6), wherein the water outlet system (6) comprises a heat exchanger (61) and a cooling tower (62); the heat exchanger (61) communicates with an outlet of the membrane wall (21) and/or the smooth tube (22); the cooling tower (62) communicates with the heat exchanger (61) and is configured to discharge sewage to a blowoff pipe.

17. The comprehensive performance measurement system for an insulation structure of a boiler setting according to claim 4, further comprising a water outlet system (6), wherein the water outlet system (6) comprises a heat exchanger (61) and a cooling tower (62); the heat exchanger (61) communicates with an outlet of the membrane wall (21) and/or the smooth tube (22); the cooling tower (62) communicates with the heat exchanger (61) and is configured to discharge sewage to a blowoff pipe.

18. The comprehensive performance measurement system for an insulation structure of a boiler setting according to claim 5, further comprising a water outlet system (6), wherein the water outlet system (6) comprises a heat exchanger (61) and a cooling tower (62); the heat exchanger (61) communicates with an outlet of the membrane wall (21) and/or the smooth tube (22); the cooling tower (62) communicates with the heat exchanger (61) and is configured to discharge sewage to a blowoff pipe.

19. The comprehensive performance measurement system for an insulation structure of a boiler setting according to claim 12, further comprising a water outlet system (6), wherein the water outlet system (6) comprises a heat exchanger (61) and a cooling tower (62); the heat exchanger (61) communicates with an outlet of the membrane wall (21) and/or the smooth tube (22); the cooling tower (62) communicates with the heat exchanger (61) and is configured to discharge sewage to a blowoff pipe.

20. The comprehensive performance measurement system for an insulation structure of a boiler setting according to claim 6, further comprising a water outlet system (6), wherein the water outlet system (6) comprises a heat exchanger (61) and a cooling tower (62); the heat exchanger (61) communicates with an outlet of the membrane wall (21) and/or the smooth tube (22); the cooling tower (62) communicates with the heat exchanger (61) and is configured to discharge sewage to a blowoff pipe.
